(19) United States
(12) Patent Application Publication
(10) Pub. No.: US 2019/0168328 A1
(43) Pub. Date: Jun. 6, 2019

(54) Wheel Repair Method and Hardware

(71) Applicant: Creighton Harmon, Havana, FL (US)

(72) Inventor: Creighton Harmon, Havana, FL (US)

(21) Appl. No.: 16/211,163

(22) Filed: Dec. 5, 2018

Related U.S. Application Data
(60) Provisional application No. 62/594,865, filed on Dec. 5, 2017.

(51) Int. Cl. B23K 9/04; B23P 6/04

(52) U.S. Cl. CPC B23K 9/04; B23P 2700/50; B23P 6/04

(57) ABSTRACT

A method of repairing a vehicle wheel along with hardware suitable for carrying out the method. Any crack in the wheel is repaired by conventional welding. Any deformation is preferably trued as well. A reinforcing ring is then provided for the wheel's inner flange. This reinforcing ring is placed proximate the wheel's inboard flange. The reinforcing ring is then welded to the wheel. The process and hardware typically create a wheel that is stronger than it was in its original state and may also be used to reinforce undamaged wheels.

### CROSS-REFERENCES TO RELATED APPLICATIONS

This non-provisional patent application claims the benefit of an earlier-filed provisional application. The earlier application named the same inventor. It was filed on Dec. 5, 2017 and was assigned App. Ser. No. 62/594,865.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

### 1.Field of the Invention

The present invention pertains to the field of vehicle wheels. More specifically, the invention comprises a method of reinforcing a metal vehicle wheel, along with hardware for carrying out the method. The present invention is particularly applicable to motor vehicle wheels but can be applicable to other types of wheels.

### 2. Description of the Related Art

Vehicle wheels are often damaged by running over obstructions such as curbs. Cast wheels are particularly susceptible to this type of damage. A sudden impact will often crack the casting, rendering the wheel inoperable. The crack substantially weakens the wheels' structure. Since most modern tire and wheel assemblies do not use an inner tube, the crack also makes it impossible to pressurize the tire and wheel assembly.

It is known to repair a crack in a cast wheel using conventional, welding methods. Most such wheels are made of aluminum, so the most commonly used repair method is gas tungsten arc welding (“GTAW”), also known as tungsten inert gas (“TIG”) welding. The GTAW method uses a non-consumable tungsten electrode, which produces a high-temperature arc between itself and the material being welded. Oxidation is prevented by using an inert shielding gas, usually argon or helium, to protect the weld area and electrode. A separate filler metal is often added to the weld as it progresses along the crack.

The GTAW method is preferred since it provides the user improved control over the weld, which in turn should produce stronger, better quality welds. Thus, GTAW is commonly used to repair cracks or holes in wheels. The crack or hole is welded using this method to create weld beads in the damaged area. The weld beads may then be ground flat.

FIGS. 1-3 illustrate the prior art repair methodology. FIG. 1 shows a prior art wheel 12. Hub 18 is connected to the outer portions of the wheel by a plurality of spokes 32. Wheel face 34 is the inward-facing surface of hub 18. This surface is configured to press against the mounting face on the motor vehicle (and secured in place using separate lug nuts or lug bolts which are not shown).

In the example of FIG. 1, an elongated crack 26 has developed in wheel 12. FIG. 2 shows the same wheel from the side. The reader will observe how crack 26 extends through barrel 36. The wheel's barrel 36 extends from inboard flange 28 to outboard flange 38. Inboard lip 30 is formed on the outer perimeter of inboard flange 28 while outboard lip 40 is formed on the outer perimeter of outboard flange 38.

The location of the crack in the example of FIG. 2 is typical for a curb strike. When installed, the inboard flange lies closer to the centerline of the vehicle than the outboard flange. Hub 18 and spokes 32, however, are much closer to the wheel's outboard flange 38 than inboard flange 36. This is one of the conventional design features of a cast wheel. The wheel's interior must accommodate a rotating brake disk and its associated brake caliper hardware. Thus, hub 18 is offset toward the outboard side of the wheel.

In a curb strike, outboard flange 38 and inboard flange 28 may receive a comparable blow. However, the proximity of the spokes to outboard flange 38 means that the outboard flange is much better reinforced. As a result, a crack in a cast wheel almost always occurs proximate inboard flange 28 (as shown in the examples of FIGS. 1 and 2).

FIG. 3 simplistically depicts the prior art repair process. Wheel 12 is often placed in some type of fixture 46. Welding torch 24 is then used to weld crack 26. The welder may place a few tack welds. A weld bead 42 is run along the entire length of the crack. A separate filler rod 44 is often used to provide additional material as the arc moves along. Once the weld bead is finished and cooled, surface grinding is usually employed to provide a good finish. The affected portion of the wheel faces inboard when mounted on the car. Thus, the repair work is not visible.

Those skilled in the art will know that the welding process will alter the physical characteristics of the repaired region. The filler material may not be the same aluminum alloy as used in the initial casting. In addition, the back side of the weld may not receive shielding gas and the back side may therefore oxidize during the weld. As a result of these and other phenomena, the repaired wheel is often susceptible to additional cracking.

The present invention comprises a process and hardware that gives repaired wheels more strength than the prior art method. It may even be used in undamaged wheels since it provides greater strength to the wheel than even its original state.

### BRIEF SUMMARY OF THE INVENTION

The present invention is directed to a method and apparatus that satisfy this need. The present invention comprises a method of repairing a vehicle wheel, along with hardware suitable for carrying out the method. Any crack or hole in the wheel is repaired by conventional welding. Any deformation is preferably trued as well. A reinforcing ring is then provided for the wheel's inboard flange.

The crack or hole in the wheel is identified and welded using conventional welding techniques, preferably including the step of grounding the welding beads flat. The reinforcing ring is placed proximate the wheel's inboard flange and welded to the wheel using conventional welding techniques. After the welding is completed the wheel can be balanced via the addition of wheel weights.

### BRIEF DESCRIPTION OF THE SEVERAL VIEWS OF THE DRAWINGS

FIG. 1 is a perspective view, showing a crack in a prior art wheel.

FIG. 2 is a perspective view, showing the wheel of FIG. 1 from a different vantage point.

FIG. 3 is a perspective view, showing a prior art wheel repair process.

FIG. 4 is a plan view, showing a reinforcing ring used in the present invention.

FIG. 5 is a sectional perspective view, showing the reinforcing ring of FIG. 4.

FIG. 6 is a perspective view, showing the prior art reinforcing ring mated to the prior art wheel.

FIG. 7 is a perspective view, showing the combination of FIG. 4 from another vantage point.

FIG. 8 is a perspective view, depicting the reinforcing ring attached to the prior art wheel by four short tack weld beads spaced at 90-degree intervals.

FIG. 9 depicts the same state as shown in FIG. 8 from another vantage point.

FIG. 10 depicts a welder running a GTAW weld bead along the joint between the reinforcing ring and the wheel.

FIG. 11 depicts the reinforcing ring after two 90-degree sections of weld have been completed.

FIG. 12 depicts the completed assembly of the wheel and the reinforcing ring.

FIG. 13 is a sectional elevation view, showing how a prior art tire bead seal mates to the inboard flange of a wheel.

FIG. 14 Is a sectional elevation view, showing how a wheel modified according to the present invention still accommodates a tire bead seal.

### REFERENCE NUMERALS IN THE DRAWINGS

12 wheel
18 hub
20 reinforcing ring
22 tank weld beads
24 welding torch
26 crack
28 inboard flange
30 inboard lip
34 wheel face
36 barrel
38 outboard flange
40 outboard lip
42 weld bead
44 filler rod
46 fixture
48 outer perimeter
50 perimeter weld bead
56 side wall
58 tire
60 bead
62 bead face
64 lip receiver

### DETAILED DESCRIPTION OF THE INVENTION

In the Brief Summary of the Invention above and in the Detailed Description of the Invention, and the claims below, and in the accompanying drawings, reference is made to particular features and method steps of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components or steps are optionally present. Where reference is made herein to a method comprising two or more defined steps, the defined steps can be carried out simultaneously (except where the context excludes that possibility), and the method can include one or more other steps which are carried out before any of the defined steps, between two of the defined steps, or after all the defined steps (except where the context excludes that possibility).

A process according to the present invention for repairing a wheel 12 comprises the steps of identifying a repair location on the wheel 12; welding a hole or a crack present in the repair location; adding a reinforcing ring 20 on the wheel 12; and welding the reinforcing ring 20 to the wheel 12. The process can optionally include the steps of grounding down a weld bead on the repair location of the wheel 12; balancing the wheel 12 once the GTAW method is complete or at any point thereafter; using a welding positioner turntable with a foot treadle; and/or welding a plurality of tack weld beads 22 on the reinforcing ring 20 and the wheel 12 prior to welding the reinforcing ring 20 to the wheel 12.

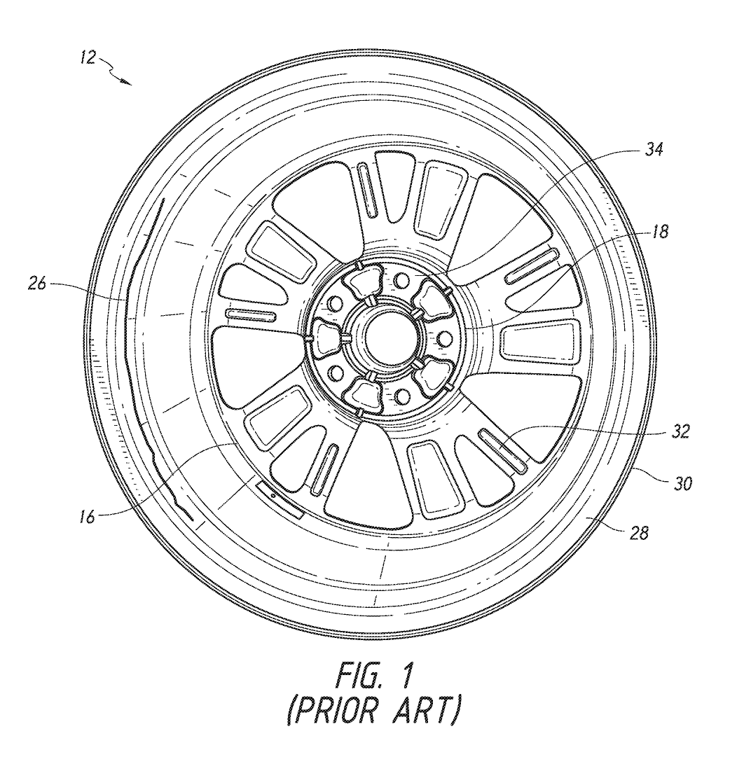

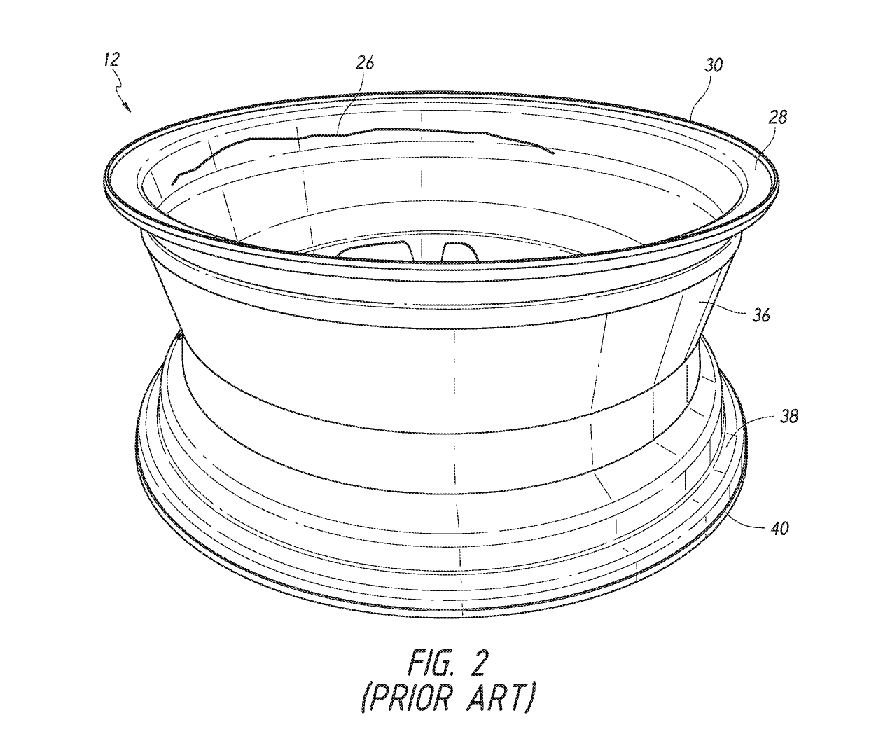

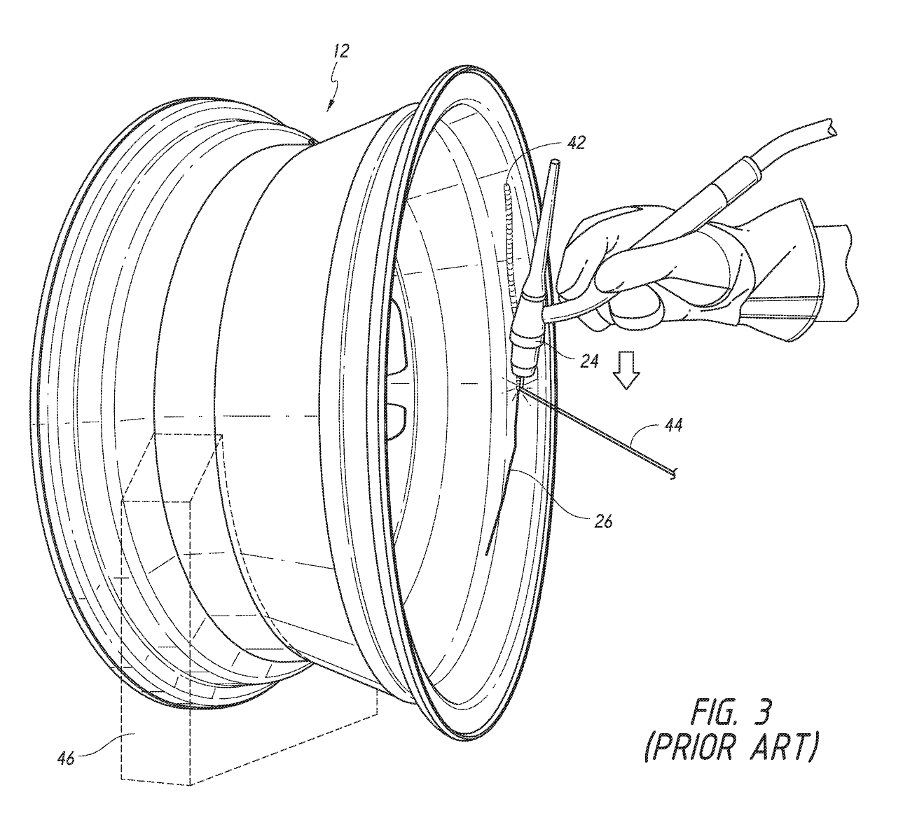

In the welding at the repair location step, the crack or hole in need of repair is welded using conventional GTAW methods, described above and depicted in FIGS. 1-3. The resulting weld bead is then optionally ground flat. The GTAW method is preferably used to weld aluminum wheels, but wheels made of other metals could be used as well.

In the optional balancing step, one or more wheel weights can be added to balance the wheel according to conventional methods. This step is preferably included in the method in order to eliminate vibration and subsequently improve the wear of the tire, increasing mileage and reducing stress on the vehicle.

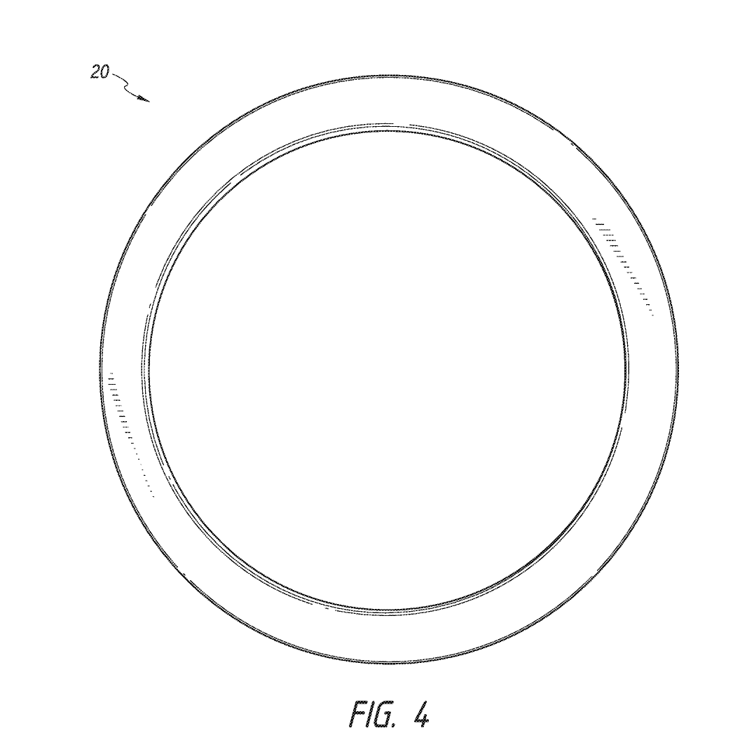

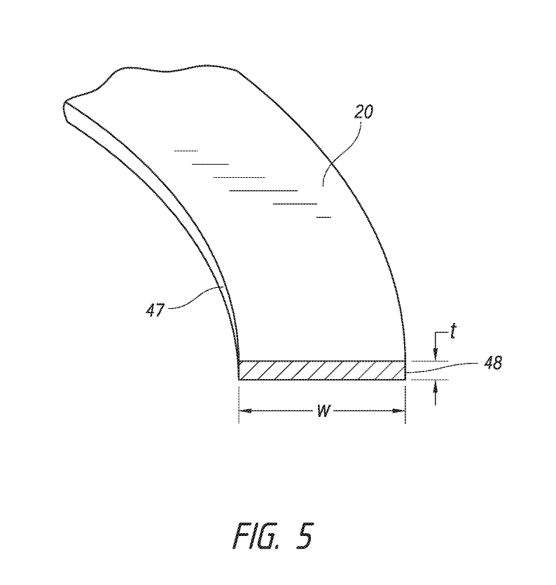

The reinforcing ring used in the present invention is preferably made of a material which can be easily welded to the wheel itself For an aluminum wheel, an aluminum reinforcing ring is preferably used. FIG. 4 shows a plan view of reinforcing ring 20. FIG. 5 provides a sectional elevation view depicting the reinforcing ring's cross section. The reinforcing ring has a circular inner perimeter 47 and a circular outer perimeter 48. The cross section has a width “w” and a thickness “t.”

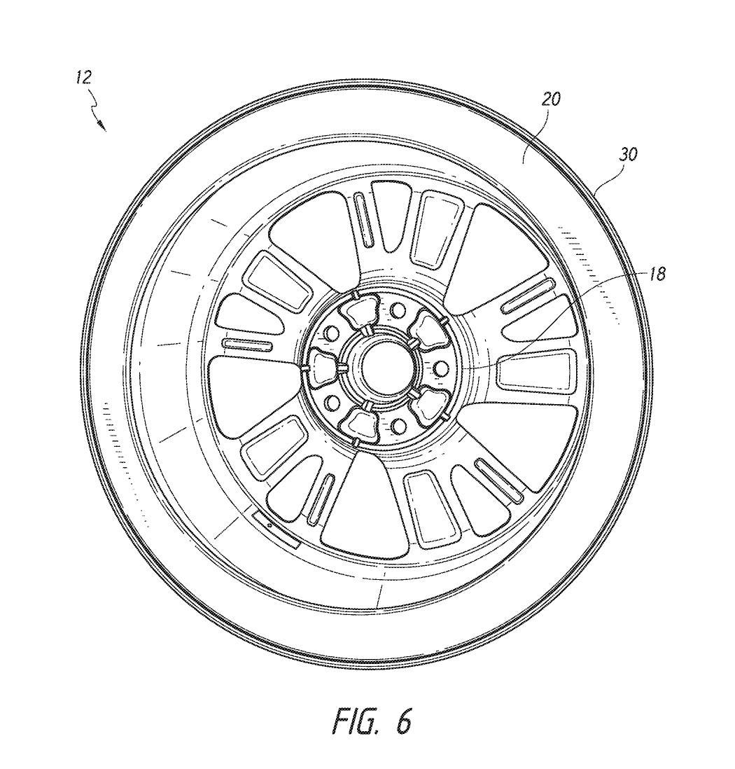

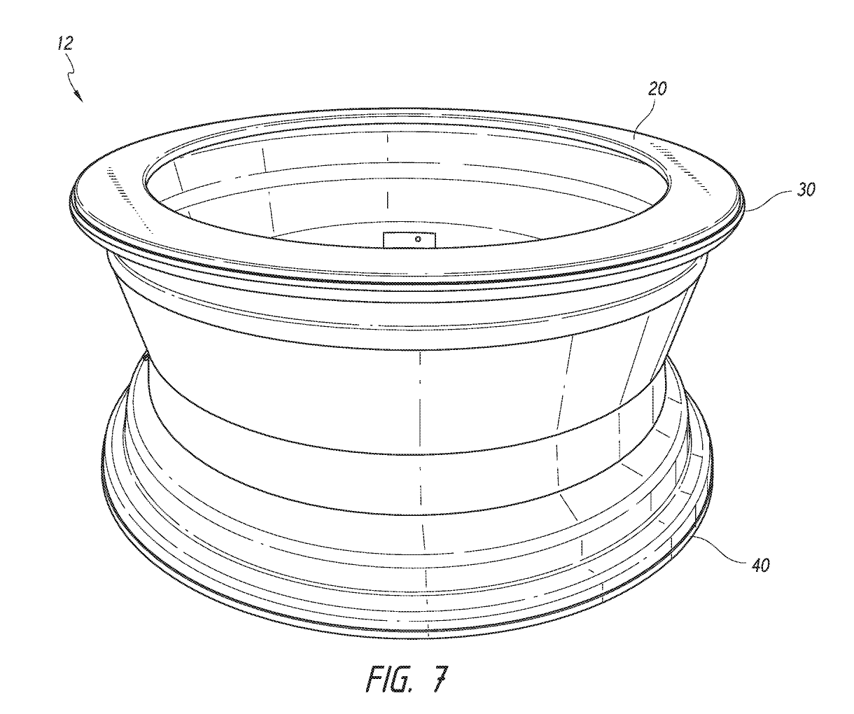

FIG. 6 shows reinforcing ring 20 mated to wheel 12. The dimeter of outer perimeter 48 (see FIG. 5) is in this example selected so that reinforcing ring 20 nests just inside inboard lip 30 of wheel 12. FIG. 7 shows the same assembly from a lateral vantage point. The reader will observe how outer perimeter 48 of reinforcing ring 20 lies just inside inboard lip 30. The gap between the outer perimeter and the inboard lip will be bridged by a weld in this example. Thus, it is preferable for the gap not to be too large. A gap anywhere from 0.00 to 0.10 inches is preferred. Small gaps are easier to weld so a gap on the low end of this range is even more preferred.

Clamps or fixtures can be used to secure the reinforcing ring in the position shown in FIG. 7. For this particular example, the reinforcing ring rests against the wheel's inboard flange and this interaction tends to bold the reinforcing ring in position without the need for external fixtures. In other embodiments external fixtures will be desirable.

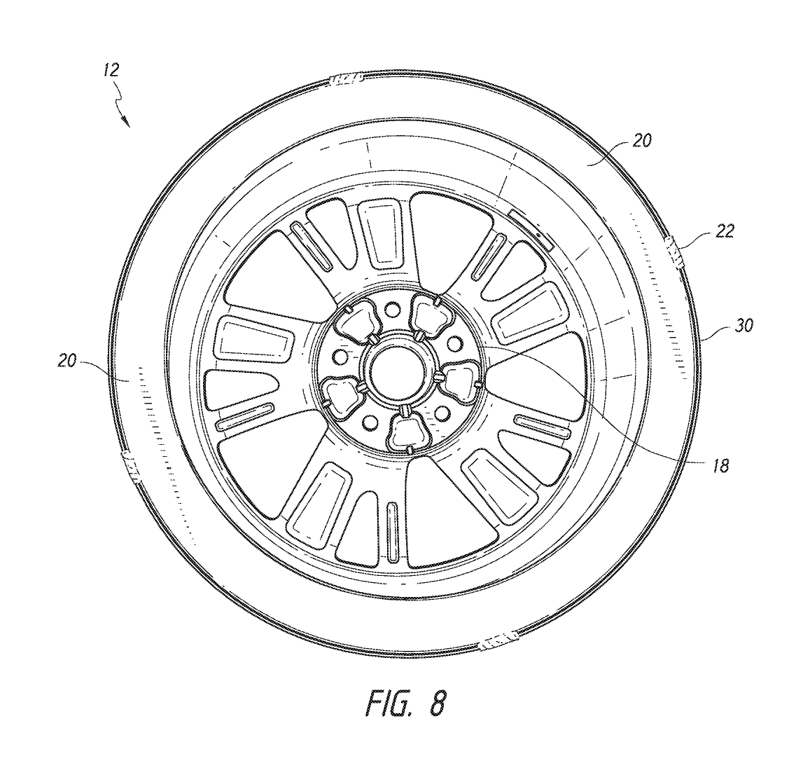

The objective in this example is the creation of a continuous weld bead between outer perimeter 48 and inboard lip 30. As those skilled in the art will know, it is advisable to provide several tack welds to hold the components in place before creating any longer welds. FIG. 8 shows the assembly after four tack welds 22 have been created. In this example, the four tack welds have been created at 90 degree intervals around the wheel's inboard lip. The tack weld beads 22 in this example are performed in the same way the final weld is to be completed, according to conventional GTAW methods.

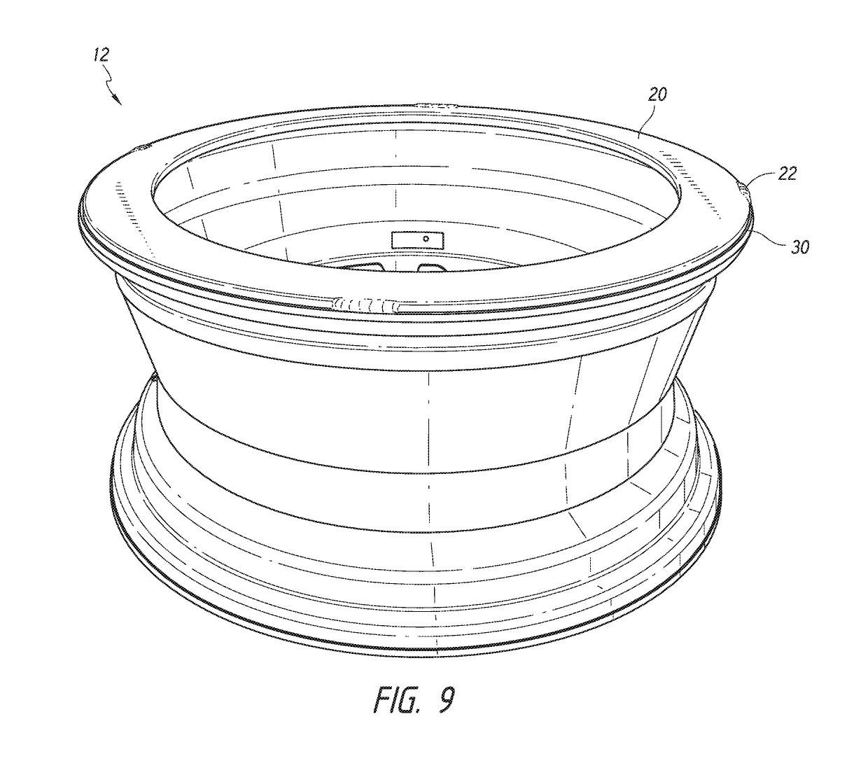

FIG. 9 shows the tack-welded assembly from a lateral vantage point. The next step in this example is to run continuous beads between each tack weld. The aluminum used for the wheel is of course quite thermally conductive. Thus, it may be necessary to allow the assembly to cool between the welding of each 90 degree segment It may be desirable to allow cooling more frequently than this.

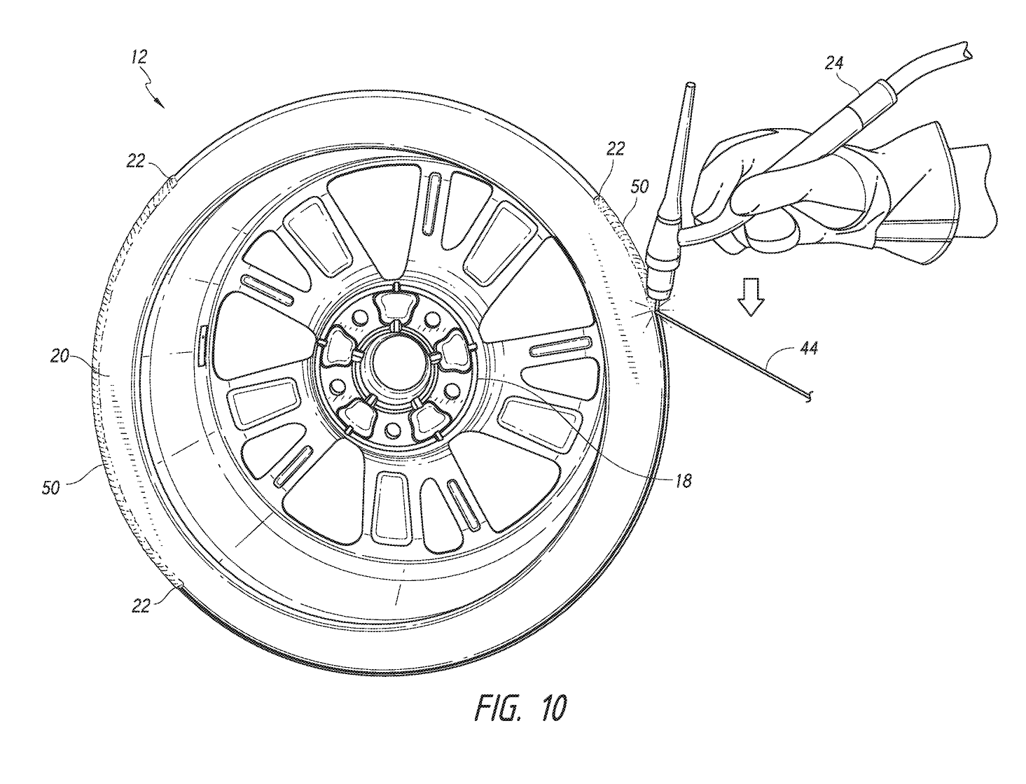

FIG. 10 shows the assembly after one perimeter weld bead 50 has been added to join two of the tack weld beads 22. The welder is shown using welding torch 24 to run a second perimeter weld bead between the pair of tack weld beads 22 on the opposite side of the wheel's perimeter. It is preferable to weld the opposite side first to avoid excessive warpage. In this example the welder is using a TIG torch and separate filler rod 44 to create a good weld.

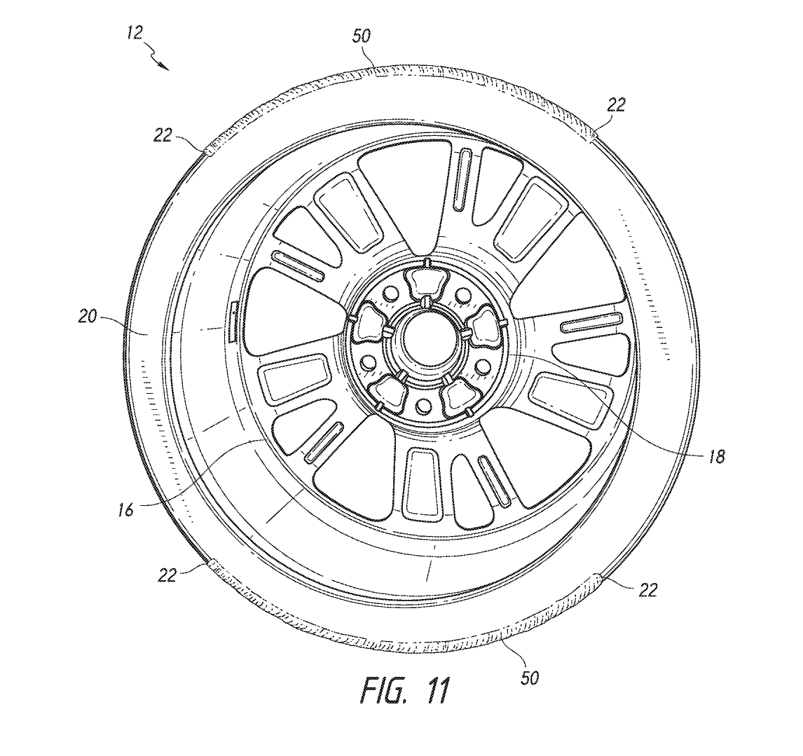

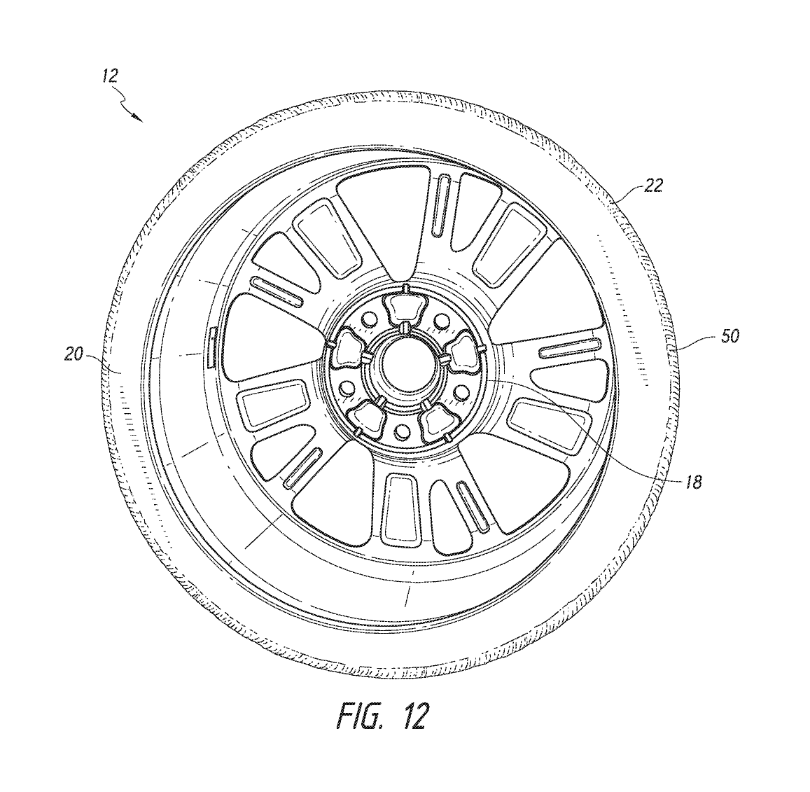

FIG. 11 shows the same assembly after two of the four perimeter weld beads 50 have been added. The welder will then run the two remaining 90 degree segments. FIG. 12 shows the completed assembly. It is possible to grind smooth the weld bead. It is even possible to mount the wheel in a lathe and turn the outward-feeing portions of the weld bead. However, these secondary operations are not necessary in most instances and the weld bead can be left in the state shown in FIG. 12.

The addition of reinforcing ring 20 proximate the wheel's inboard flange substantially strengthens the wheel. This reinforcement is provided for the wheel's weakest portion—the inboard flange area. Following the addition of the reinforcing ring the likelihood of a subsequent crack is substantially reduced.

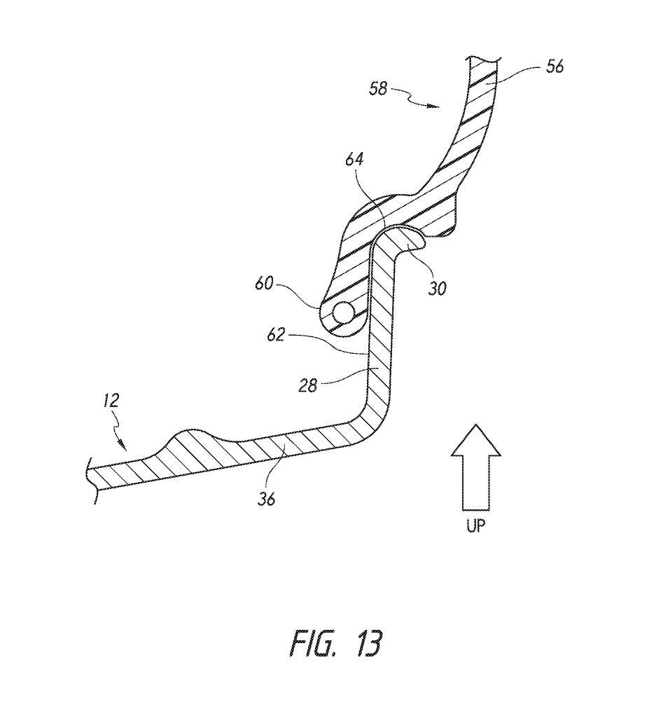

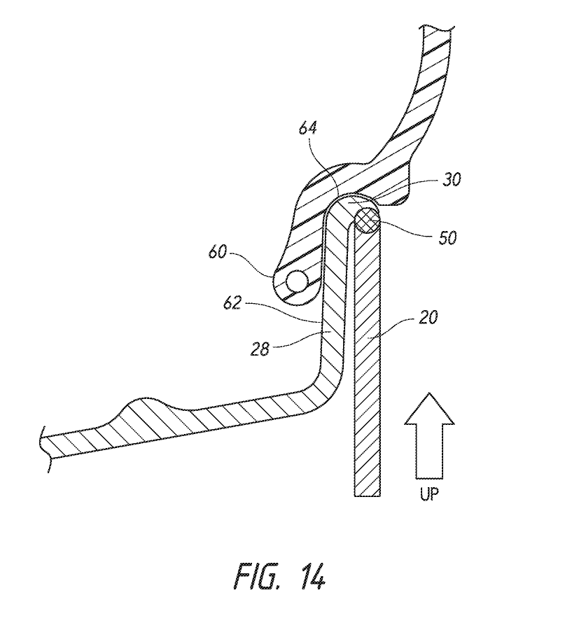

The reinforcing ring can be added in various locations other than the example shown. However, the example shown provides good access for the welding torch and is therefore a convenient location. In addition, the location shown does not interfere with the interaction of the wheel and a tire mounted on the wheel. FIGS. 13 and 14 illustrate this point.

FIG. 13 shows a sectional elevation view through the area of inboard flange 28 with a tire 58 mounted on wheel 12. The wheel is positioned upright—as it would sit when mounted on a vehicle. The portion shown is the uppermost part of the wheel. As those skilled in the art will know, a tire 58 is mounted on the wheel by forcing the tire's inboard and outboard beads over the corresponding inboard and outboard lips on the wheel. FIG. 13 shows the tires inboard bead 60 snapped over inboard lip 30. Most tires include a lip receiver 64 that engages inboard lip 30. The tire's side wall 56 extends outward from the region of the lip receiver.

When air pressure is added to the tire's interior (using a valve typically mounted on the wheel) inboard bead 60 is urged against inboard bead face 62 on inboard flange 28. The air pressure also urges the outboard bead against the outboard bead face on the opposite side of the wheel (not shown). A pressure-tight seal is thereby formed between the wheel and the tire. This seal is important, since modern tires are usually run without an inner tube. The lip receiver is not found on all tires, but it is often present. It helps to minimize air leakage when the tire is first pressurized and also helps in properly locating the bead.

FIG. 14 shows the same assembly after reinforcing ring 20 has been welded to the wheel. Perimeter weld bead 50 is formed between inboard lip 30 and reinforcing ring 20. The reader will note how the presence of the weld bead does not interfere with the mating of inboard bead 60 to inboard bead face 62, nor does it interfere with the operation of lip receiver 64.

Returning to FIG. 13, those skilled in the art will recognize that inboard flange may assume many different forms for different wheel types. In the example shown, the inboard flange 28 includes an inboard lip 30 (the lip being considered part of the flange). Not all flanges will include a distinctive lip like the one shown.

Returning to FIG. 5, some of the properties of the reinforcing ring will be discussed. For an aluminum reinforcing ring, the thickness “t” will preferably be between 0.100 and 0.500 inches. A thickness of 0.250 to 0.375 inches is even more preferable. The width “w” will be determined by two factors. First, the diameter of outer perimeter 48 should be selected to closely match the diameter of the wheel in the position where the weld is to take place. The diameter of inner perimeter 47 must be large enough to allow the wheel to slip over the brake rotor, brake caliper, associated hydraulic lines, and suspension components.

A shop carrying out the inventive process may wish to have a variety of reinforcing ring sizes available in order to accommodate variations in wheel sizes and vehicle component sizes. One particular size could accommodate a range of wheel sizes by chucking the ring in a lathe and turning down its outer perimeter, its inner perimeter, or both. Some shops may wish to “custom cut” each reinforcing ring using a water jet cutter or comparable equipment.

The present invention is a process for repairing the wheel 12 using the reinforcing ring 20. Thus, it is likely to be commonly used in car repair shops or garages. Optionally, the welder 24 may want to incorporate the step of using a welding positioner turntable while running the perimeter weld. The turntable will increase the steadiness of the welder's hands, resulting in an increase in the overall quality of the welds. The optional turntable may incorporate a foot treadle which is attached to the turntable. This will allow the welder 24 to increase or decrease the speed of rotation in order to control the weld. Usually, the process and hardware of the present invention will be incorporated into the wheel 12 by a vendor specializing in the repair process. Once the process is completed the wheel 12 will often be sent to a tire shop where a tire is put on the wheel and subsequently used by a consumer on their vehicle. Of course, there is no reason why a single vendor could not perform the wheel repair and the tire mounting operations.

The present invention boasts the advantage of creating stronger, better quality repairs on wheels. These wheels are expensive. If the wheel 12 is bent or cracked, it is known to carry out a costly repair. The prior art repair method may fail and usually does not create a result as strong as the wheel 12 was prior to becoming damaged since the wheel 12 has generally been weakened by either the original damaging event or the repair process itself. It is common for such repairs to fail—often in the area of the weld. The present invention creates a much stronger repair, increasing the longevity of the repair and the wheel 12 itself. Further, the process and hardware of the present invention may be used even on undamaged wheels, since the resulting repair is stronger than the wheel was in its original state. In some instances, the repair method and the reinforcing ring 20 have more than doubled the wheel's strength prior to repair. Thus, the present invention will result in less repairs and longer lasting wheels. Thus, the addition of a reinforcing ring to a previously undamaged wheel is certainly within the scope of the present invention (such as a wheel 12 intended for rugged, off-road use).

The reader should bear in mind that the invention is not limited to any particular location for the perimeter weld. Returning to FIG. 7, one can visualize a smaller reinforcing ring 20 intended to fit well down inside the wheel before being welded to the wheel. Such an embodiment would still provide a structural advantage. However, it would be more difficult to weld.

The preceding description contains significant detail regarding the novel aspects of the present invention. It is should not be construed, however, as limiting the scope of the invention but rather as providing illustrations of the preferred embodiments of the invention. Thus, the scope of the invention should be fixed by the claims ultimately drafted, rather than by the examples given.

Having described my invention, I claim:

1. A method of repairing a crack in a wheel having an inboard flange, an outboard flange, and a barrel connecting said inboard and outboard flanges, comprising:
(a) welding said crack;
(b) providing a reinforcing ring having an inner perimeter, an outer perimeter, and a thickness;
(c) placing said reinforcing ring proximate said inboard flange of said wheel; and
(d) while said reinforcing ring remains proximate said inboard flange of said wheel, welding said reinforcing ring to said wheel.

2. The method of repairing a crack in a wheel as recited in claim 1, wherein said step of welding said reinforcing ring to said wheel comprises welding said outer perimeter of said reinforcing ring to said wheel.

3. The method of repairing a crack in a wheel as recited in claim 2, wherein said outer perimeter of said reinforcing ring is welded to an inboard lip found on said inboard flange of said wheel.

4. The method of repairing a crack in a wheel as recited in claim 1, wherein said welding is done using the gas tungsten arc welding method.

5. The method of repairing a crack in a wheel as recited in claim 1, wherein a diameter of said outer perimeter of said reinforcing ring is made to fit closely inside an inner diameter of a lip on said inboard flange of said wheel.

6. The method of repairing a crack in a wheel as recited in claim 5, wherein a diameter of said inner perimeter of said reinforcing ring is made large enough to clear a brake disc and a brake caliper on a vehicle that said wheel will be used on.

7. The method of repairing a crack in a wheel as recited in claim 1, further comprising placing a plurality of tack weld beads at 90-degree intervals between said reinforcing ring and said wheel.

8. The method of repairing a crack in a wheel as recited in claim 3, further comprising welding said outer perimeter of said reinforcing ring to said inboard lip in one-quarter increments around said outer perimeter of said reinforcing ring while allowing said wheel and reinforcing ring to cool in between said one-quarter increments.

9. A method of reinforcing a wheel having an inboard flange, an outboard flange, and a barrel connecting said inboard and outboard flanges, comprising:
(a) providing a reinforcing ring having an inner perimeter, an outer perimeter, and a thickness;
(b) placing said reinforcing ring proximate said inboard flange of said wheel; and
(c) while said reinforcing ring remains proximate said inboard flange of said wheel, welding said reinforcing ring to said wheel.

10. The method of reinforcing a wheel as recited in claim 9, wherein said step of welding said reinforcing ring to said wheel comprises welding said outer perimeter of said reinforcing ring to said wheel.

11. The method of reinforcing a wheel as recited in claim 10, wherein said outer perimeter of said reinforcing ring is welded to an inboard lip found on said inboard flange of said wheel.

12. The method of reinforcing a wheel as recited in claim 9, wherein said welding is done using the gas tungsten arc welding method.

13. The method of reinforcing a wheel as recited in claim 9, wherein a diameter of said outer perimeter of said reinforcing ring is made to fit closely inside an inner diameter of a lip on said inboard flange of said wheel.

14. The method of reinforcing a wheel as recited in claim 13, wherein a diameter of said inner perimeter of said reinforcing ring is made large enough to clear a brake disc and a brake caliper on a vehicle that said wheel will be used on.

15. The method of reinforcing a wheel as recited in claim 9, further comprising placing a plurality of tack weld beads at 90-degree intervals between said reinforcing ring and said wheel.

16. The method of reinforcing a wheel as recited in claim 11, further comprising welding said outer perimeter of said reinforcing ring to said inboard lip in one-quarter increments around said outer perimeter of said reinforcing ring while allowing said wheel and reinforcing ring to cool in between said one-quarter increments.
